(19) United States
(12) Patent Application Publication
(10) Pub. No.: US 2026/0134400 A1
(43) Pub. Date: May 14, 2026

(54) SYSTEM AND METHOD FOR AI-DRIVEN AUTOMATED INTERVIEWING AND EVALUATION PLATFORM

(71) Applicant: POSSOBUILDTECHNOLOGIES PVT. LTD., Hyderabad (IN)

(72) Inventors: Uma Maheswara Rao NELLURI, Monroe Township, NJ (US); Somasekhara Kalyan JATA, Hyderabad (IN); Akshay DIXIT, Agra (IN); Hari Prasad PIRIDI, Bengaluru (IN); Rakesh RAVEENDRAN, Hyderabad (IN)

(21) Appl. No.: 19/442,935

(22) Filed: Jan. 7, 2026

Related U.S. Application Data
(63) Continuation-in-part of application No. PCT/IN2024/051117, filed on Sep. 7, 2024.

(30) Foreign Application Priority Data
Sep. 7, 2023 (IN) 202341046074
Sep. 7, 2024 (WO) PCT/IN2024/051117

(51) Int. Cl. G06Q 10/1053; G06N 3/0475

(52) U.S. Cl. CPC G06Q 10/1053; G06N 3/0475

(57) ABSTRACT

The present invention relates to the fields of Computer Science, Artificial Intelligence, Machine Learning and Deep Learning, specifically focusing on Human Resources technology, automated interviewing, and evaluation processes. The present invention discloses various embodiments of an AI-driven interview system and method enabling automated and structured interviews of various prospective candidates wherein data from structured and unstructured job description texts (201) are extracted using LLM/NLPs (706) and contextual questions are framed. The embodiments disclosed is also adapted to evaluate and assess the skill of the interview candidate (110) on one or more parameters and assign a rating (113) to the user using LLMs. The embodiments disclosed are also adapted to artificially generate video of interviewer (117), perform fraud detection (111) and incorporate redundancy for human intervention (610).

### CROSS-REFERENCE TO RELATED APPLICATIONS

This patent application is a bypass continuation-in-part of PCT Patent Application No. PCT/IN2024/051117, filed Sep. 7, 2024, which claims the benefit of Indian Patent Application No. 202341046074, filed Sep. 7, 2023.

### FIELD OF INVENTION

The invention relates to the fields of Computer Science, Artificial Intelligence (“AI”), Machine Learning (“ML”) and Deep Learning (“DL”), specifically focusing on Human Resources (“HR”) technology, automated interviewing, and evaluation processes.

### BACKGROUND OF DISCLOSURE

In the current corporate landscape, the recruitment process is both time-consuming and resource-intensive. Traditional methods often involve multiple rounds of interviews, which can lead to scheduling errors, hours of interviewer effort, human interviewer bias, and inconsistent interview experiences. This leads to inefficiencies in hiring and potentially missed opportunities for finding the right candidate. Existing solutions attempt to automate parts of the recruitment process but do not fully integrate AI capabilities, resulting in a process that is still largely manual and inefficient.

In the examples disclosed, the principal object of the system and method in the present disclosure reduces HR efforts in the hiring and interviewing processes by conducting industry agnostic interviews using AI, ML and DL to evaluate prospective candidates and ascertain whether such candidates are fit for a particular role, thereby synergistically increasing the efficiency of HR.

In some examples, the system and method may eliminate human biases and human errors while evaluating and selecting the best possible candidate for a particular role by fully integrating AI capabilities in the hiring process.

### SUMMARY OF THE INVENTION

The present invention discloses various embodiments of an AI-driven interview system and method that enables automated and structured interviews of various prospective candidates. The various embodiments disclose a scalable intelligent bot framework which is configured for an automated interview process using generative AI, speech recognition adapted to analyse sentiment, confidence, clarity of speech etc., speech synthesis and real-time talking video synthesis for conversation and analyses a plurality of input parameters such as body language, facial expression and eye movements, and allows for an unbiased evaluation of prospective candidates, featuring various safeguards such as fraud detection.

The system and method described in the present disclosure is a cutting-edge AI platform that can conduct structured automated interviews, saving valuable time and resources for companies while ensuring a fair, unbiased, and engaging interview process. The system and method disclosed is adapted to be scalable and capable for performing multiple interviews at the same time, transforming the way businesses recruit.

In some embodiments, the system and method disclosed in the present invention reduces HR efforts in the hiring and interviewing processes by conducting industry agnostic interviews using AI, ML and DL to evaluate prospective candidates and ascertain whether such candidates are fit for a particular role, thereby synergistically increasing the efficiency of HR.

In some examples, the system and method may eliminate human biases and human errors while evaluating and selecting the best possible candidate for a particular role by fully integrating AI capabilities in the hiring process.

The present invention is adapted to reduce the costs and time associated with the interview process through effective and scalable system and methods for automating interview processes. The system and methods disclosed herein provide a synergistic increase in process efficacy and reduction in time spent in interviewing a prospective candidate.

The present invention relates to advancements in computer-based artificial intelligence systems and methods for conducting interactive, stateful human- computer communication. The disclosed system and method introduces a technical framework that enables computers to conduct adaptive, multimodal interviews by integrating natural language understanding, speech and audio signal processing, computer vision, and reinforcement-learning-based decision models within a unified architecture. Unlike conventional systems that rely on static scripts or isolated AI components, the invention enables dynamic question generation, continuous contextual awareness, and real-time evaluation of human responses across multiple sessions and communication channels, thereby extending the capabilities of computer systems in interactive decision-making environments.

Further, the invention advances the field of AI-driven interaction by introducing techniques for contextual memory retention, multimodal behavioral analysis, and interview integrity assurance during live human-computer exchanges. The system utilizes vector embeddings, similarity-based retrieval, adaptive dialogue sequencing, and synchronized analysis of textual, audio, temporal, and visual signals to evaluate response authenticity, behavioral consistency, and interaction patterns over time. By correlating multiple independent computational signals—such as linguistic structure, response timing, speech characteristics, gaze patterns, and behavioral continuity-the system improves the reliability and robustness of automated interview processes. Collectively, these innovations enhance how computers model, interpret, and respond to complex human behavior, representing an advancement in conversational AI, multimodal analytics, and interactive computing systems.

### BRIEF DESCRIPTION OF DRAWINGS

This invention is illustrated with the help of the following drawings.

FIG. 1 relates to the functional overview of the system and method disclosed. The said drawing illustrates the flow of the automated interview method disclosed, including the interview orchestration.

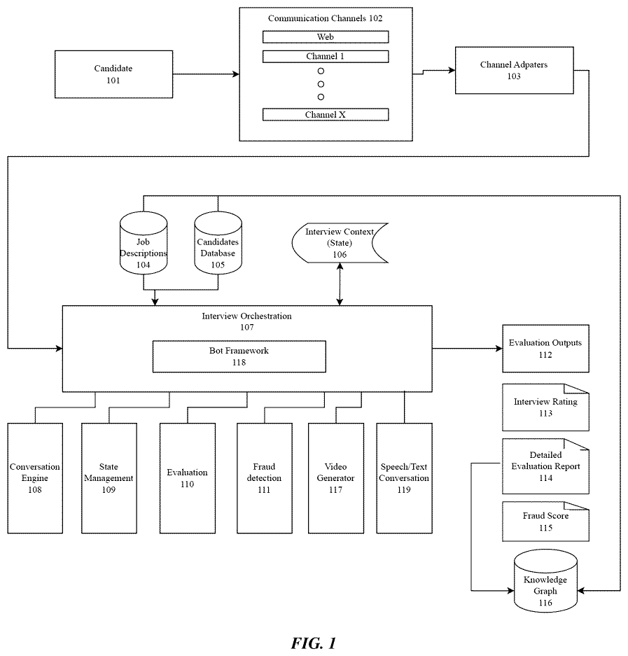

FIG. 2 illustrates the end-to-end interview flow.

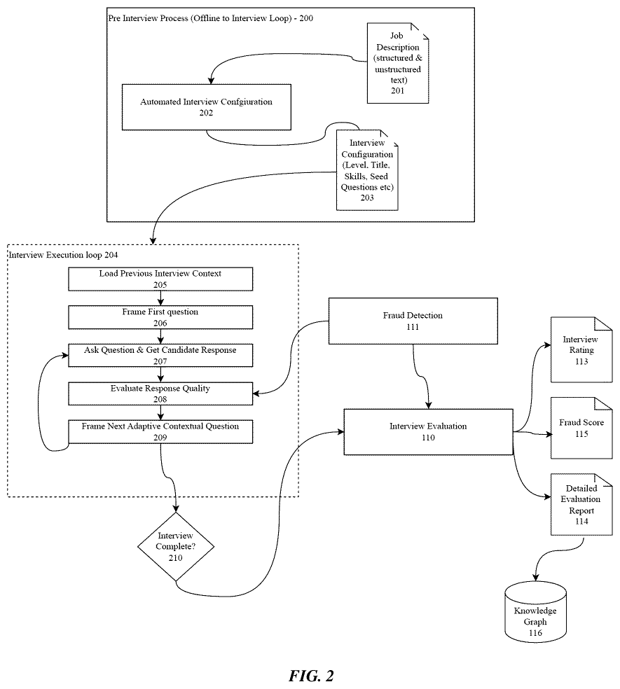

FIG. 3 relates to the automated interview configuration and illustrates the basic process of skill extraction and seed question generation from unstructured job descriptions.

FIG. 4 relates to Interview context and adaptive feedback loop and illustrates how the system and method is adapted to frame subsequent questions using AI and Large Language Models.

FIG. 5 relates to the interview evaluation module and illustrates how the AI-based evaluation process using one or more AI models, LLM/NLP evaluate various parameters, as disclosed in the present system and method.

FIG. 6 relates to the fraud detection module and illustrates how fraud detection in the present disclosure takes place.

FIG. 7 relates to the system overview, and the interaction between the various modules of the system and method claimed.

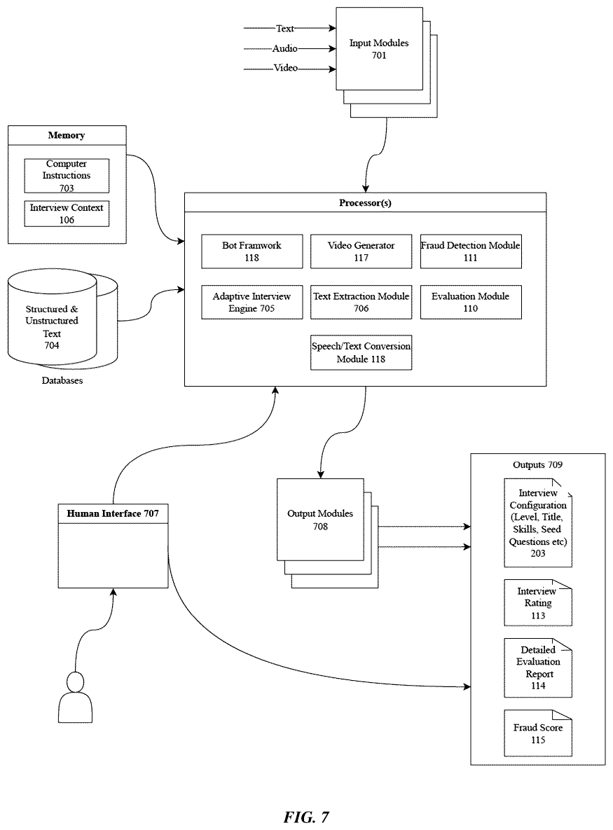

### DETAILED DESCRIPTION OF THE INVENTION

The present disclosure describes multiple embodiments of an AI-driven recruiting/interviewing system and method. For promoting a better understanding of the principles of the invention, references may be made to embodiments or flowcharts illustrated in the figures (if any), and specific language may be used to describe them. The same must not be construed to be limiting the scope of the intended invention in any way, shape, or form. However, such alterations and further modifications in the illustrated system, and such further applications of the principles of the invention as would normally occur to those persons ordinarily skilled in the art, must be construed as being within the scope of the present invention.

It is understood by a person ordinarily skilled in the art that the foregoing general description and the following detailed description are exemplary in nature and not intended to be restrictive. The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more sub-systems or elements or structures or components preceded by the term “comprises”, does not, without more constraints, preclude the existence of other, sub-systems, elements, structures, components, additional sub-systems, additional elements, additional structures, or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those persons ordinarily skilled in the art/field to which this invention belongs. The description of all system, methods, and examples provided herein are only illustrative and not intended to be limiting. The system, methods, and examples provided herein are only illustrative and not intended to be limiting.

An embodiment of the present disclosure provides for a system and method for AI-driven interview platform adapted to enable automated and structured interviews. The said system is developed to replicate a real-world interview through AI and seeks to replicate real world questions and evaluate the answers by a prospective candidate to determine whether such a candidate is fit for a particular role. The said system leverages a Bot Framework (118) to develop an enterprise-grade intelligent bot, enabling a conversational AI experience for prospective candidates. The Bot Framework (118) utilises state-of-the-art natural language processing (NLP) and ML models to facilitate real-time, dynamic interactions. It includes components for dialogue management, user intent recognition and context retention, ensuring coherent and context-aware conversations. The said system is adapted to integrate the Bot Framework (118) with various communication channels (102) (which include various productivity applications such as Microsoft Teams®, Slack® etc.). This integration is achieved through the use of channel adapters (103) that map the specific communication protocols of each channel to a unified interaction model within the Bot Framework. These adapters (103) handle the conversion of messages to and from the format required by each channel, ensuring that the bot can understand and respond appropriately regardless of the platform being used. The integration also supports features such as adaptive cards, which provide interactive UI elements that can be rendered consistently across different platforms. This integration allows the system to function across all these channels uniformly, providing a seamless user experience regardless of the selected communication medium for the prospective candidates. The system supports advanced features such as multi-turn conversations, where the bot can maintain context across multiple interactions, even if these occur on different platforms or at different times. The central bot framework implementation orchestrates (107) all communication activities, managing state and context across sessions and channels. All communication activities are processed through the central bot framework implementation, ensuring that each interaction with the present system, across any channel, gets processed accurately and consistently. The framework includes logging and monitoring tools that track interactions in real-time, providing insights into bot performance and user behaviour. Additionally, the system incorporates robust error handling and fallback mechanisms to manage unexpected inputs and maintain a smooth conversational flow. The central bot framework also integrates with backend systems and databases to fetch and store information as required during the interview process, enhancing the bot's ability to provide relevant and timely responses.

Another embodiment of the above integrated chatbot system employs adaptive dialogues (705) to conduct structured, dynamic interviews across the aforementioned channels. The dialogues are adapted to recognise and react to user input, providing a natural, engaging conversation with the candidates. The adaptive dialogues are also adapted to capture the end of an answer. For example., the user can click on a button in the adaptive card to indicate that they have completed answering a question.

Another embodiment of the integrated chatbot is adapted to implement a state management system (109), which ensures that the bot maintains context across different channels and sessions (106), allowing the present system to pick up conversations from where it left off, even if a candidate drops off and re-joins the interview.

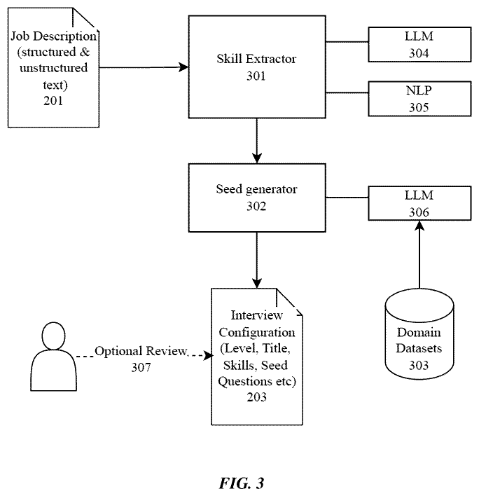

Yet another embodiment described in the instant disclosure is adapted with an Automated Interview Configuration (FIG. 3), which aids in the conduction of interviews based on skills determined from the Job Description (201), which feature ensures the conduction of uniform interviews and also helps the HR team in conserving valuable time. One of the key components of the present embodiment of the system is its ability to perform automatic skill extraction (301) from unstructured job description text (201). This is achieved using Natural Language Processing (“NLP”) techniques (305), specifically Large Language Models (“LLMs”) (304), to analyse the job descriptions and extract the competencies and skills required for a particular job role. Once the skills have been extracted from the job description, the system utilises its Generative AI capabilities to automatically generate seed questions (302) tailored to those skills. The question generation process involves leveraging AI Models, such as Large Language Models (306) (e.g. GPT-3.5, LLaMA) fine-tuned on domain specific interview question datasets (303) to generate contextually relevant questions. These models are specifically trained on large corpora of interview questions and job descriptions to ensure high-quality relevant question generation. The system also balances the difficulty level of generated questions based on the job requirements and seniority level. The system ensures diversity in generated questions by comparing their semantic similarity using fine-tuned sentence embedding models and filtering out redundant or highly similar questions. The system does Human-in-the-loop Validation by incorporating a mechanism for human experts to review (307) and approve generated questions, ensuring quality and relevance. This feedback is used to continuously improve the fine-tuning of the language models. These seed questions serve as a starting point for the interview process and provide a standardised set of questions to assess candidates'proficiency in the identified skills. By automating the seed question generation (302) by using fine-tuned language models, the present system reduces the need for interviewers to manually create questions based on the extracted skills. This not only saves time but also ensures consistency and fairness in the interview process, as all candidates are evaluated using the same set of questions, tailored to the specific job requirements and generated by models specifically trained for this task.

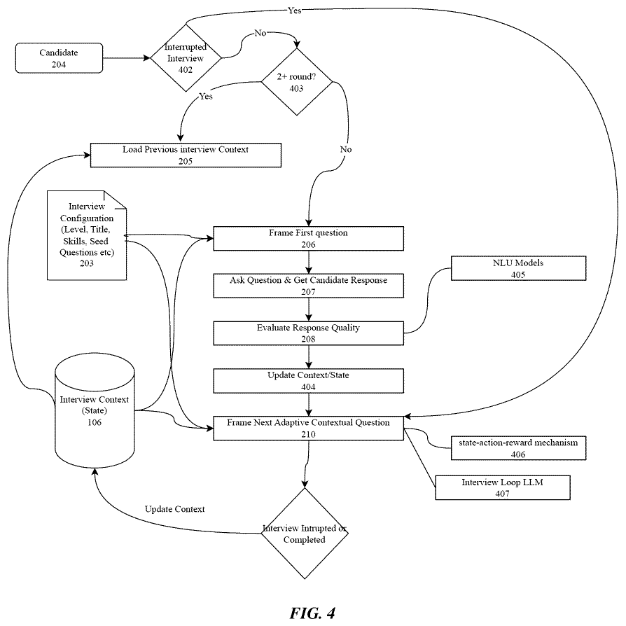

Another embodiment uses advanced generative AI models to drive dynamic, context-aware conversations with candidates, making the automated process feel more natural and interactive (FIG. 4). Using AI, the present system is adapted to recognise candidates'answers and accordingly formulate relevant follow-up questions, promoting a more in-depth, meaningful interview process. This may be achieved through integration with LLMs (407) such as Generative Pre-trained Transformer (“GPT”) based models. The present system may utilise any of the multiple paid and open-source models with various integrated customisations.

Yet another embodiment (FIG. 4) is specifically designed to retain the context of previous interview rounds for each candidate (204). This functionality is implemented using a state management system (109) that stores conversation history and candidate data as embeddings computed using a pre-trained embedding model in a distributed vector database. Each interaction with a candidate is embedded into a high-dimensional vector space, capturing metadata such as time-stamps, dialogue states, and key points from the conversation. The system employs nearest neighbour vector similarity search retrieval algorithms, enabling efficient and rapid retrieval of relevant historical data. When conducting subsequent interview rounds, this stored context is dynamically retrieved and integrated into the current conversation flow. The system leverages advanced neural language understanding (NLU) models (405) to interpret the candidate's previous responses (208) and generate contextually appropriate follow-up questions (209). These questions are formulated by analysing embeddings from earlier interactions, ensuring continuity and relevance in dialogue. By retaining the context (106), the system can ask follow-up questions that are relevant and build upon previous conversations. This capability significantly enhances the interview and evaluation process by enabling the system to delve deeper into the candidate's qualifications, responses, and overall performance. Context-aware questioning may improve the depth of the interview but also enables the system and method disclosed to detect inconsistencies or changes in the candidate's responses over time, leading to a more thorough and accurate assessment. The system's ability to maintain context across multiple interview rounds provides a seamless and engaging experience for candidates, closely mimicking the natural progression of a human-led interview process. Furthermore, the system may incorporate privacy and security measures to ensure that all stored data is protected and used in compliance with relevant regulations. Access controls, encryption techniques, and secure authentication mechanisms are employed to safeguard candidate information, ensuring confidentiality and integrity of the interview data.

In another embodiment, the system continuously adapts to the candidate's ability during the course of the interview (204), and frames subsequent questions depending upon the accuracy in the previous questions (210). The traditional approach of automated hiring is largely static, with pre-established question sets not necessarily reflecting a candidate's full potential. In contrast, the present system is adapted to leverage the reinforcement learning and accordingly dynamically adapt the interview process based on the candidate's performance. The system learns to optimise its strategy of asking questions over time, continuously tailoring the interview to the candidate's demonstrated abilities. The present system is adapted to implement a reinforcement learning algorithm configured to dynamically adapt to a candidate's abilities during an interview (FIG. 4). At the core of this approach is a feedback loop: the system poses a question (206), the candidate responds (207), the system evaluates the response (208), and then decides on the next question based on this evaluation (210). Reinforcement learning trains the system to optimise its questioning strategy. It utilises a state-action-reward mechanism (406) to learn the best sequence of questions that maximizes the chance of obtaining high-quality responses from a candidate. The state in this scenario is the candidate's current demonstrated ability, the action is the next question to ask, and the reward is the quality of the candidate's response. The system leverages past interactions and immediate feedback to select optimal questions, reducing bias and improving accuracy in assessing candidate capabilities. By employing reinforcement learning, the system enhances the effectiveness of interviews, offering a dynamic and adaptive experience that saves time and resources. It demonstrates promise in distinguishing between candidates and gathering valuable insights, even in short interviews.

In another embodiment, the system is adapted to convert text to speech and vice versa (119), enabling real-time verbal communication with candidates, enhancing the interview experience.

In yet another embodiment, system is adapted to enhance the interview process by generating a video of the interviewer (117), adding an additional dimension to the experience. This feature aims to bring about a human-like element to the interview, resulting in a more personable and engaging interaction. For this we leverage state-of-the-art Neural Radiance Fields (“NeRF”) models to perform Real-Time Talking Video Synthesis.

Being an AI enabled, the system is adapted to eliminate the bias of the interviewer in the evaluation of candidates, based on candidates'responses (110), promoting fair hiring practices. Post-interview, the system is adapted to provide for a quantified evaluation (112) of each candidate based on their responses, aiding hiring managers in making data-driven decisions. The evaluation process can also aid in identifying skill gaps within the organisation and guide targeted training and development programs.

In another embodiment, the said system is adapted to be equipped with advanced capabilities to perform a comprehensive technical skill assessment (504). The system is adapted to evaluate a prospective candidates'performance at each question level and assigns a rating between 1 and 10 based on the response provided using Large Language Models (LLMs) (514). These ratings are then aggregated across different skills using statistical techniques and the questions asked within each skill to arrive at an overall score for the interview (113), and the decision to either hire or not to hire such candidate.

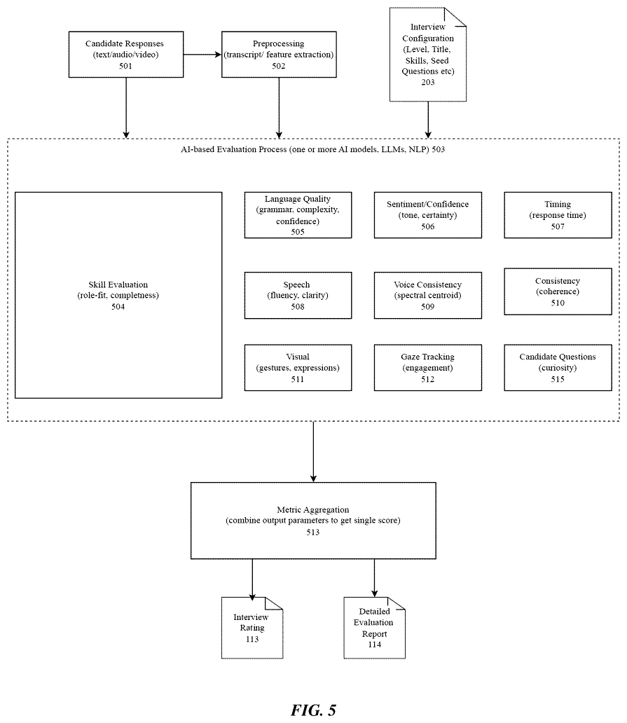

In yet another embodiment, the system is adapted to incorporate advanced text evaluation features that greatly enhance the assessment of candidates during interviews (FIG. 5). By leveraging powerful language processing techniques using NLP, the system is adapted to provide valuable insights into candidates'fluency, clarity, grammatical accuracy, readability, curiosity, sentiment, and use of confident language. The key evaluation features of the present system are as follows:
a) Fluency & Clarity of Speech (508): An embodiment is adapted to analyse the fluency and clarity of candidates'speech by assessing the number of pauses or fillers (e.g., “um,” “uh”) used during the interview. A lower number of pauses or fillers indicates smoother and more confident communication.
b) Grammatical Mistakes in Text (505): An embodiment is adapted to perform comprehensive error analysis to identify grammatical mistakes in the text provided by prospective candidates. This analysis includes dependency parsing to identify issues such as subject-verb agreement, incorrect word ordering, and the presence of missing or extra words in a sentence. Additionally, the system is adapted to employ part-of-speech (POS) tagging to identify errors related to verb tense, preposition usage, and pronoun usage. The system also incorporates grammar rule-based error identification to detect and highlight grammatical errors accurately.
c) Readability/Complexity of Responses (505): An embodiment is adapted to measure the readability of candidates'answers using the Flesch-Kincaid Grade level. This metric provides an approximate grade level needed to comprehend a piece of text. For example, a score of 8 means that the text can be read by 8th-grade students. The evaluation of readability helps assess how effectively candidates can convey their thoughts and ideas in a clear and understandable manner.
d) Curiosity Assessment (515): The system considers the number of questions asked by candidates during the interview as a positive indicator of curiosity. Candidates who actively engage in the conversation by asking relevant questions are considered to demonstrate a genuine interest in the role and a proactive approach to learning.
e) Sentiment Analysis (506): An embodiment employs sentiment analysis techniques to determine the overall sentiment expressed in candidates'responses. This analysis helps identify whether the candidates'tone is positive or negative, providing insights into their attitude and emotional disposition during the interview.
f) Use of Confident Language (505): An embodiment is adapted to assess the use of confident language by identifying specific phrases such as “I can” and “I will” in candidates'responses. The presence of such confident language is considered to indicate a strong belief in one's abilities and a positive mindset.

In yet another embodiment, the system is adapted to integrate powerful audio evaluation features that enhance candidate assessment during interviews. Leveraging advanced audio analysis techniques such as spectral analysis, prosody analysis, and machine learning models, the system provides detailed insights into candidates'speaking patterns, vocal characteristics, and response times. The system employs digital signal processing (DSP) methods to capture and analyse audio signals. The system is adapted to analyse candidates'average speaking rate, which is typically expected to fall within the range of 125 to 150 words per minute. This analysis is conducted using automated speech recognition (ASR) systems combined with text processing algorithms to accurately measure the word count and time intervals. A higher speaking rate may indicate enthusiasm and engagement in the conversation; however, it can also be indicative of nervousness a feeling of being rushed (506). Conversely, a lower speaking rate may suggest thoughtfulness and deliberation, but could also indicate hesitation or unpreparedness. In another embodiment, the system evaluates various vocal characteristics, including pitch, volume and tone. Pitch analysis involves measuring the fundamental frequency of the speaker's voice using Fast Fourier Transforms (FFT) to detect variations that might indicate stress or confidence (510). Volume analysis assesses the loudness levels throughout the conversation, providing insights into assertiveness and engagement. Tone analysis uses deep learning sequential models such as Recurrent Neural Networks (RNNs), Transformers, Attention Mechanisms etc., to classify the emotional state of the candidate, discerning between positive, neutral and negative sentiments.

An embodiment is also adapted to assess the consistency of a speaker's voice throughout the interview, particularly focusing on the spectral centroid (509). A high spectral centroid signifies a consistently high-pitched voice, which is brighter and clearer. In contrast, a low spectral centroid indicates a consistently low-pitched voice, which may sound dull and less clear. Inconsistencies in pitch during the interview may be indicative of nervousness or uncertainty. This helps in identifying candidates'vocal patterns and evaluating their composure and confidence levels.

Another embodiment of the system is adapted to measure a prospective candidates'average response time to questions asked during the interview using precise time-stamping mechanisms (507). This involves measuring the time interval between the end of a question and the start of the candidate's response. Slower response times may suggest that a candidate is not entirely sure of their answers or requires more time to formulate a thoughtful response. Very slow response times could potentially indicate that a candidate is browsing the internet or referring to external sources for answers. The analysis of response times helps evaluate a prospective candidates'ability to think on their feet, demonstrate knowledge, and provide timely and coherent responses. The system utilises sequential models like RNNs, Transformers, Attention Mechanisms etc. to model and analyse temporal dependencies in speech, providing deeper insights into the candidate's conversational dynamics. These models help in understanding the flow and structure of dialogue, capturing nuances that are indicative of communication competence. By combining these audio analysis techniques, the system provides a comprehensive evaluation of the candidate's communication style and level of confidence. This multi-faceted approach ensures a robust assessment of verbal skills, enhancing the overall interview process.

Another embodiment is adapted to leverage sophisticated computer vision techniques like Convolutional Neural Networks (“CNN”), Vision Transformers (“ViT”) etc., to analyse the video to derive insights into candidate behaviour, communication skills, and presentation abilities during interviews. The system is adapted to analyse candidates'body language by recognising and interpreting their hand gestures during interviews (511). This feature enables a deeper understanding of candidates'confidence, engagement, and professionalism. Positive gestures convey strong communication skills and confidence, while negative or distracting gestures may indicate nervousness or lack of composure.

Another embodiment of the system is adapted to integrate the video analysis feature focuses on analysing facial expressions to gauge candidates'emotional state and reactions during interviews (511). By capturing subtle changes in facial expressions such as smiles, frowns, or raised eyebrows, the system provides valuable insights into candidates'enthusiasm, engagement, and authenticity.

Yet another embodiment of the system utilises a gaze tracking technology to analyse a prospective candidates'eye movements and evaluate their level of engagement and attentiveness which is a crucial aspect of effective communication (512). Strong and focused eye contact are indications of active listening and genuine interest, while frequent shifts in gaze may suggest distraction or lack of concentration or fraud.

Another embodiment of the system is adapted to analyse a prospective candidates'choice of professional attire, such as suits and ties or appropriate business casual wear and makes suggestions to the candidate for an overall better impression in preparation for the interview (511).

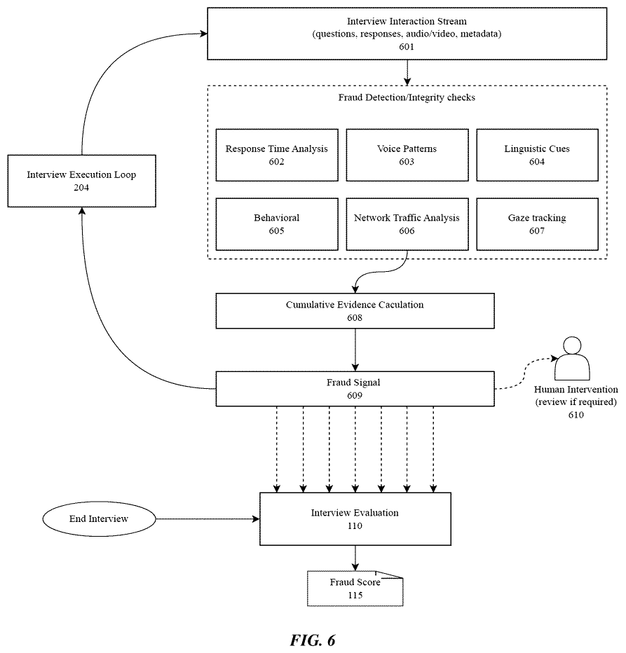

Yet another embodiment of the system is adapted to perform fraud detection (FIG. 6), thereby ensuring the integrity and authenticity of the hiring process. These include the deployment of various eye and body movement tracking modules (607) and also employing various computer tracking and tab freezing. By leveraging advanced technologies and data analysis techniques we proactively identify fraudulent behaviours during the interview. By comparing a candidate's responses to a vast database of pre-existing interview transcripts, essays, or publicly available content, the system is adapted to identify instances of potential plagiarism or fraudulent behaviour.

Another embodiment of the system is adapted to measure a prospective candidates'average response time to questions posed during the interview (602). A slower response time than expected based on the complexity of the question may suggest that a candidate might be searching on the internet. However, it is important to note that slow response times alone do not indicate fraudulent behaviour and this is merely used as one of the parameters out of all the others. Fraudulent behaviour is flagged if multiple factors are satisfied.

An embodiment of the system is adapted to ensure that only the candidate and interviewer are present in a call by way of detecting any attempts at unauthorised participation. This may be achieved by adapting the system to prevent multiple individuals from joining the call apart from the designated candidate and the interviewer. By implementing secure authentication mechanisms, the system ensures that only the intended participants can engage in the interview (611). This feature helps maintain the confidentiality and integrity of the interview process. Another embodiment of the system is adapted to detect multiple attempts to join a call by different individuals using the same candidate user account. The system is enabled with voice recognition technology to identify and distinguish the voices of different participants in the call. The system can detect this scenario and flag it as a potential violation.

Yet another embodiment of the system is equipped with advanced modules adapted to detect the misuse of AI avatars during an interview. In some cases, individuals may attempt to use AI-powered avatars or voice synthesis technology to impersonate a candidate and take the interview on their behalf. The system employs a multi-faceted approach to identify such fraudulent attempts by employing the following methods:
a) Voice Pattern Analysis (603): The system utilises spectral analysis techniques to examine the frequency components, formants, and prosodic features of a candidate's voice. It compares these patterns against a database of known human voice characteristics to detect anomalies indicative of synthetic speech;
b) Response Time Monitoring (602): The system implements a sophisticated timing mechanism to measure the latency between questions and responses. Abnormally consistent or rapid response times may indicate the use of an AI system rather than human cognition and speech production;
c) Linguistic Cue Detection (604): NLP algorithms are employed to analyse the semantic content, syntactic structure and pragmatic aspects of the candidate's responses. The system is trained to identify linguistic patterns that are characteristic of LLMs, such as unusual coherence across diverse topics or the absence of common speech disfluencies;
d) Behavioural Consistency Analysis (605): The system tracks micro-expressions, eye movements, and other non-verbal cues through computer vision algorithms. Inconsistencies between verbal and non-verbal communication can indicate the use of an AI avatar;
e) Dynamic Question Generation: To challenge potential AI avatars, the system dynamically generates questions that require real-world knowledge, emotional intelligence, or contextual understanding that the current AI models typically struggle with;
f) Biometric Verification: The system may incorporate continuous biometric authentication methods, such as facial recognition or voice biometrics, to ensure the identity of the candidate matches with the photograph of the user in the database;
g) Network Traffic Analysis (606): In cases of remote interviews, the system monitors network traffic patterns to detect anomalies that might indicate involvement of external AI systems. By analysing these various aspects of communication in real-time, the system employs deep learning classifiers to identify suspicious behaviour. If the cumulative evidence surpasses a pre-determined threshold, the system flags the interview as a potential violation, triggering further investigation or immediate termination of the interview process. This multi-layered approach significantly enhances the robustness of the system against sophisticated AI-powered impersonation attempts, maintaining the integrity of the interview process.

Another embodiment of the system is adapted to leverage the rich dataset encompassing interviews, candidates, skills, and related to build a knowledge graph (116), which allows to uncover hidden insights, discover relationships and make data-driven decisions. By utilising the knowledge graph (116), the system can perform intelligent candidate matching, identifying the most suitable candidates for specific roles based on their qualifications, skills, and compatibility with the company's culture.

To ensure better scalability, the system can be adapted to utilise a microservices-based architecture, where different aspects of the interview process are handled by dedicated services. This modularity will enable better scalability and isolation of services, ensuring that a surge in demand in one service does not impact the overall performance of the platform. The system is also adapted to incorporate resilient design principles and redundancy measures to ensure uninterrupted service. By duplicating critical components of the system and implementing effective fail-over strategies, the system ensures high availability and reliability of the interviewing service. The system is also adapted to incorporate the principles of load balancing and elastic scaling, uses cloud-based resources that can be scaled up or down based on the demand, thereby maintaining optimal performance levels even during peak interview times.

Another embodiment of the system employs an efficient concurrency management model that allows simultaneous operation of multiple instances of the interviewing bot across different channels. This is achieved by using the Bot Framework's turn-based concurrency model, which ensures smooth operation even when multiple interactions are initiated simultaneously.

### LIST OF REFERENCE NUMERALS

101—Candidate
102—Communication Channels
103—Channel Adapters
104—Job Descriptions
105—Candidates Database
106—Interview Context (State)
107—Interview Orchestration
108—Conversation Engine
109—State Management
110—Evaluation
111—Fraud Detection
112—Evaluation Outputs
113—Interview Rating
114—Detailed Evaluation Report
115—Fraud Score
116—Knowledge Graph
117—Video Generator
118—Bot Framework
119—Speech/Text Conversion
200—Pre Interview Process (Offline to Interview Loop)
201—Job Description (structured & unstructured Text)
202—Automated Interview Configuration
203—Interview Configuration (Level, Title, Skills, Seed Questions etc.)
204—Interview Execution Loop
205—Load Previous Interview Context
206—Frame First Question
207—Ask Question & Get Candidate Response
208—Evaluate Response Quality
209—Frame Next Adaptive Contextual Question
210—Interview Complete?
301—Skill Extractor
302—Seed Generator
303—Domain Datasets
304—LLM (Skill extractor)
305—NLP
306—LLM (Seed generator)
307—Optional (human) review 402—Interrupted Interview?
403—2^{nd}+round?
404—Update Context/State
405—NLU Models
406—State-Action-Reward Mechanism
407—Interview Loop LLM
501—Candidate Responses (text/audio/video)
502—Preprocessing (transcript/feature extraction)
503—AI-based Evaluation Process (one or more AI models, LLMs, NLP)
504—Skill Evaluation (role-fit, completeness)
505—Language Quality (grammar, complexity)
506—Sentiment/Confidence (tone, certainty)
507—Timing (response time)
508—Speech (clarity, fluency)
509—Voice consistency (spectral centroid)
510—Consistency (coherence)
511—Visual (gestures, expressions)
512—Gaze tracking (engagement)
513—Metric Aggregation (combine output parameters to get single score
515—Candidate Questions (curiosity)
601—Interview Interaction Stream (questions, responses, audio/video, metadata)
602—Response Time Analysis
603—Voice Patterns
604—Linguistic Cues
605—Behavioural
606—Network Traffic Analysis
607—Gaze Tracking
608—Cumulative Evidence Calculation
609—Fraud Signal (score)
610—Human Intervention (review if required)
701—Input Module(s)
702—Memory
703—Computer Instructions
704—Structured and Unstructured Text
705—Adaptive Interview Engine
706—Text Extraction Module
707—Human Interface
708—Output Module(s)
709—Outputs

We claim,

1. A system for automating interviews through Artificial Intelligence, said system comprising:
A memory adapted to store and execute computer executable instructions; and
One or more processor(s), wherein the said processor(s) are adapted to:
Retrieve data from one or more database(s);
Extract data from structured or unstructured text;
Integrate an bot-framework configured to conduct interviews with prospective candidates;
Receive one or more of user inputs through one or more input modules;
Analyse the user inputs on the basis of one or more parameters;
output information through one or more output modules, adapted to receive user feedback;
Artificially generate a video of interviewer;
Perform fraud detection analysis on the basis of one or more parameters; and
Incorporate redundancy for human intervention;
Characterized in that, one or more processor(s) are adapted to:
Generate human-readable contextual questions based on extracted text data;
Generate subsequent contextual seed questions and dynamically adapt the interview process based on user feedback received;
Retain the context of previous interview rounds for each user;
Recall previous conversations and contexts at a subsequent stage;
Analyse and generate the subsequent sequence of questions based on feedback received from User; and
Analyse and evaluate skill assessment based on feedback received and on the basis of the analysis of one or more of parameters and
assign a rating to the user using Large Language Models.

2. The system as claimed in claim 1, wherein the input module comprises at least one audio input, at least one video input, the output module comprises at least one audio output and at least one video output.

3. The system as claimed in claim 1, wherein the Artificial Intelligence model is trained on one or more interview questions and job descriptions.

4. The system as claimed in claim 1, wherein the automatic text extraction from structured or unstructured text is achieved utilising Natural Language Processing techniques.

5. The system as claimed in claim 3, wherein the system is adapted to generate seed questions on the basis of the extracted text functionally coupled with at least one Generative Artificial Intelligence model.

6. The system as claimed in claim 1, wherein the bot framework is adapted to integrate with one or more channels by way of channel adapters.

7. The system as claimed in claim 1, wherein the bot framework is adapted to implement one or more state management module(s) to maintain context across one or more channels or sessions, and use the said context to analyze the user's previous responses and generate contextually appropriate follow-up questions by leveraging Neural Language Understanding models.

8. The system as claimed in claim 1, wherein the video of the interviewer is generated using Neural Radiance Fields models adapted to perform real-time talking video synthesis.

9. The system as claimed in claim 2, wherein the said system is adapted to model and analyse temporal dependencies in speech and provide deeper insights into the user's conversational dynamics.

10. The system as claimed in claim 2, wherein the said system is adapted to leverage at least Convolutional Neural Networks and Vision Transformers to analyse the audio and video input and derive insights into the user behaviour, body language, communication skills and presentation abilities.

11. The system as claimed in claim 2, wherein the analysis of fraud detection is achieved by employing at least one of gaze tracking technology, body movement tracking technology, computer tracking technology, voice pattern analysis, response time monitoring, linguistic cue detection, behavioural consistency analysis, dynamic question generation, biometric verification, network traffic analysis and detection of avatars of users generated through Artificial Intelligence.

12. The system as claimed in claim 1, wherein the evaluation is adapted to output knowledge graph for intelligent candidate matching based on one or more parameters including qualifications, skills and compatibility.

13. A method for automating interviews using Artificial Intelligence, with the said method comprising:
Retrieving data from one or more database(s);
Extracting data from structured or unstructured text;
Integrating a bot-framework adapted to conduct interviews with prospective candidates;
Receiving one or more user inputs through one or more input modules;
Analysing the user inputs on the basis of one or more parameter(s);
Generating human-readable contextual questions based on extracted text data;
output information through one or more output modules, adapted to receive user feedback;
Generating subsequent contextual seed questions and dynamically adapt the interview process based on user feedback received;
Retaining the context of previous interview rounds for each user;
Recalling previous conversations and contexts at a subsequent stage;
Artificially generating a video of interviewer;
Evaluating skill of user based on feedback received from user and on analysis of one or more parameters and assign a rating to the user using Large Language Models;
Perform fraud detection analysis on the basis of one or more parameters; and
Incorporating a redundancy for human intervention.

14. The method as claimed in claim 13, wherein the automatic text extraction from an unstructured text is achieved utilising Natural Language Processing techniques.

15. The method as claimed in claim 13, wherein the subsequent contextual seed questions are generated through Generative Artificial Intelligence model adapted to drive dynamic, context-aware conversations with the user.

16. The method as claimed in claim 13, wherein the dynamic adaptation based on user feedback leverages reinforcement learning and generates subsequent contextual questions based on the accuracy of the previous questions, which is achieved by way of a feedback loop comprising a ‘state-action-reward’ mechanism, wherein the system poses a question, the user response is recorded, and based on the evaluation of the response by the system, the next question is output to the user.

17. The method as claimed in claim 13, wherein the video of the interviewer is generated using Neural Radiance Fields models adapted to perform real-time talking video synthesis.

18. The method as claimed in claim 13, wherein the user input parameters comprises at least one of:
speech fluency and clarity characteristics derived from one or more of pauses or fillers,
grammatical accuracy of user,
complexity of responses by user,
consistency of user's voice,
curiosity of user,
sentiment of user,
use of confident language by user,
speaking patterns of user,
vocal characteristics of user,
response times of user,
body language of user,
hand gestures of user,
facial expressions of user,
eye movements of user,
body movements of user, and
attire of user.

19. The method as claimed in claim 13, wherein the user is assigned a rating between 1 to 10 based on the responses during the interview, and the ratings are aggregated across different skills using statistical methods.

20. The method as claimed in claim 19, wherein the said consistency of the user's voice is assessed by focussing on the spectral centroid.
